(19) United States
(12) Patent Application Publication
(10) Pub. No.: US 2024/0031664 A1
(43) Pub. Date: Jan. 25, 2024

(54) INTEGRATED SURVEILLANCE SYSTEM AND METHODS FOR CAPTURING SENSOR DATA CONTROLLED BY SECURITY GATEWAY

(71) Applicant: Barrett Morgan, Salt Lake City, UT (US)

(72) Inventor: Barrett Morgan, Salt Lake City, UT (US)

(21) Appl. No.: 18/357,861

(22) Filed: Jul. 24, 2023

Related U.S. Application Data
(60) Provisional application No. 63/495,274, filed on Apr. 10, 2023.
(60) Provisional application No. 63/369,185, filed on Jul. 22, 2022.

(51) Int. Cl. H04N 23/61; H04B 7/155; G08B 13/196; G08B 19/00

(52) U.S. Cl. CPC H04N 23/61; H04B 7/15507; G08B 13/19608; G08B 19/005

(57) ABSTRACT

Systems and devices for fault tolerant surveillance systems. A system includes a server and a security gateway in communication with the server by way of a network. The system includes a camera in communication with the security gateway, wherein the camera is installed at a location under surveillance. The security gateway comprises a processor configured to execute instructions including receiving an alarm event from one or more sensors installed at the location under surveillance, and, in response to receiving the alarm event, instructing the camera to capture a series of image frames.

### CROSS-REFERENCE TO RELATED APPLICATIONS

This application claims the benefit of U.S. Provisional Patent Application No. 63/369,185, filed Jul. 22, 2022, titled “SURVEILLANCE DEVICE WITH NETWORK SIGNAL REPEATER AND BATTERY CHARGER,” and further claims the benefit of U.S. Provisional Patent Application No. 63/495,274, filed Apr. 10, 2023, titled “SURVEILLANCE DEVICE WITH NETWORK SIGNAL REPEATER AND BATTERY CHARGER,” which are incorporated herein by reference in their entirety, including but not limited to those portions that specifically appear hereinafter, the incorporation by reference being made with the following exception: In the event that any portion of the above-referenced provisional applications are inconsistent with this application, this application supersedes the above-referenced provisional applications.

### TECHNICAL FIELD

The disclosure relates generally to surveillance components and particularly to cameras and speakers associated with surveillance systems.

### BACKGROUND

It is becoming increasingly common for property owners to deploy surveillance systems to monitor and protect their property. Surveillance systems may include cameras, motion sensors, speakers, microphones, and other devices to determine whether an intruder has entered a property. Surveillance systems may be used to monitor indoor and outdoor spaces at a property and may be configured to alert a property owner or law enforcement authority when an intruder enters the property.

In many cases, an intruder will seek to cut power to a building and/or surveillance system components within the building. When this occurs, the network connection and surveillance components may lose power and immediately stop functioning. This negates the benefits of the surveillance system and is an undesirable feature of most surveillance systems.

Considering the foregoing, disclosed herein are systems, methods, and devices for facilitating continued operation of surveillance system components when power is lost, and further for facilitating communications between surveillance system components when power is lost.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic diagram of a system for facilitating communications between a security gateway of a surveillance system and various components of the surveillance system;

FIG. 2A is a schematic diagram of a cloud-based database comprising fault-tolerant servers for increased data availability and security;

FIG. 2B is a schematic diagram of a system and process flow for signing a user on to a cloud-based database;

FIG. 3A is a schematic diagram of a system for facilitating wireless communications between components of a surveillance system;

FIG. 3B is a schematic diagram of a system for facilitating wireless communications between components of a surveillance system and a monitor station;

FIG. 4 is a schematic diagram of a system and process flow for communications between a security gateway and security cameras of a surveillance system;

FIG. 5 is a schematic diagram of a system and process flow for an alarm event triggered by a security gateway;

FIG. 6 is a schematic diagram of a system and process flow for a camera status event triggered by one or more security cameras of a surveillance system;

FIG. 7 is a schematic diagram of a system comprising a doorbell surveillance device and a chime comprising dual connectivity;

FIG. 8A is a schematic diagram of components of a chime charger comprising a network connectivity repeater and a battery charger;

FIG. 8B is a schematic diagram of a doorbell surveillance device interacting with an external power device;

FIG. 8C is a schematic diagram of a doorbell surveillance device interacting with a home notification device;

FIG. 9 is a schematic flow chart diagram of a method for an alarm activation process; and

FIG. 10 illustrates components of an example computing device.

### DETAILED DESCRIPTION

Disclosed herein are systems, methods, and devices for fault-tolerant surveillance components that can withstand a loss of power or a fault in an electrical system. The surveillance devices described herein include a battery power backup and further include dual connectivity. The battery power backup provides a means for the surveillance devices to continue capturing sensor data and communicating with a security gateway even when hardwired power is cut off. The dual connectivity provides a means for the surveillance devices to communicate with a security gateway and/or communicate with one another by way of wireless Wi-Fi® network protocols and further by way of radiofrequency protocols.

In some cases, it is important to ensure that surveillance devices continue to operate when power is lost. For example, an intruder may immediately seek to cut power to a building and/or individual surveillance components within the building. In this case, it is important to ensure that surveillance components, including cameras, microphones, motion sensors, heat sensors, and so forth, continue to gather data and provide the data to a security gateway. Additionally, it is important that surveillance components may continue to emit alarms and otherwise deter the intruder from remaining in the building.

In an implementation disclosed herein, a surveillance device comprises a camera and further comprises dual connectivity capabilities. The surveillance device includes a wireless antenna that enables the surveillance device to wireless communicate by way of a Wi-Fi® network connection, for example on an 802.11 Wi-Fi® protocol by way of a 2.4 GHz band. The surveillance device may further include a radiofrequency antenna that enables the surveillance device to communicate with other devices even when the Wi-Fi® network connection is lost. The surveillance device may include a hardwired electricity component configured to draw power from an electrical system and may further include a battery power backup. The surveillance device may be configured to switch to the battery backup as needed.

In a further implementation disclosed herein, a chime includes a speaker configured to emit an auditory notification. The chime may be in communication with a security gateway and one or more surveillance devices. The chime further includes dual connectivity and a battery powered backup when the chime can no longer draw power from an electrical system. The chime further includes one or more battery chargers. The one or more battery chargers are configured to charge a backup battery for the chime itself and/or charger a battery for another surveillance device such as a doorbell surveillance device.

In an implementation disclosed herein, a surveillance system server determines that a non-authorized person, such as a trespasser, prowler, lurker, or other un-authorized person, is currently present at a property. The surveillance system server makes this determination based on real-time sensor data received from an onsite surveillance system. The surveillance system server cross-checks a log of authorized persons to determine whether the person currently located at the property is in fact authorized to be located at the property at the current time. In response to determining the non-authorized person is not authorized to be located at the property at the current time, the surveillance system server may instruct one or more chimes or other alarms to emit an auditory notification and/or light-based notification.

Many property owners have a surveillance system of some kind. Numerous surveillance systems exist in the market with varying degrees of security. Surveillance systems may include outdoor cameras, indoor cameras, doorbell cameras, motion sensors, window sensors, door sensors, noise sensors, heat sensors, cold sensors, moisture sensors, carbon monoxide sensors, fire sensors, smoke sensors, speakers, and so forth. A surveillance system may include an alarm component that might sound an alarm at the property, might send a notification to a monitoring system, might send a notification to the property owner or some other property management company, might notify local law enforcement authorities, might notify local fire authorities, and so forth. Some surveillance systems will automatically send an alert to the property owner (or other authorized individual) each time a sensor is triggered, for example, each time a person is detected in a camera image, each time a motion sensor is triggered, each time a door or window is opened, and so forth. These alerts may be turned off when the system is disarmed, for example when the property owner is at home.

Some surveillance systems create an alert when a person enters the property or is near the property. These alerts can be triggered by motion sensors, door sensors, window sensors, camera image data, and so forth. However, these alerts do not provide an indication of whether the person who has entered the property (or is near the property) is authorized to enter the property. This increases the security risk for the property owner.

Before the structures, systems, and methods for fault-tolerant communications and alarms within a surveillance system are disclosed and described, it is to be understood that this disclosure is not limited to the structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

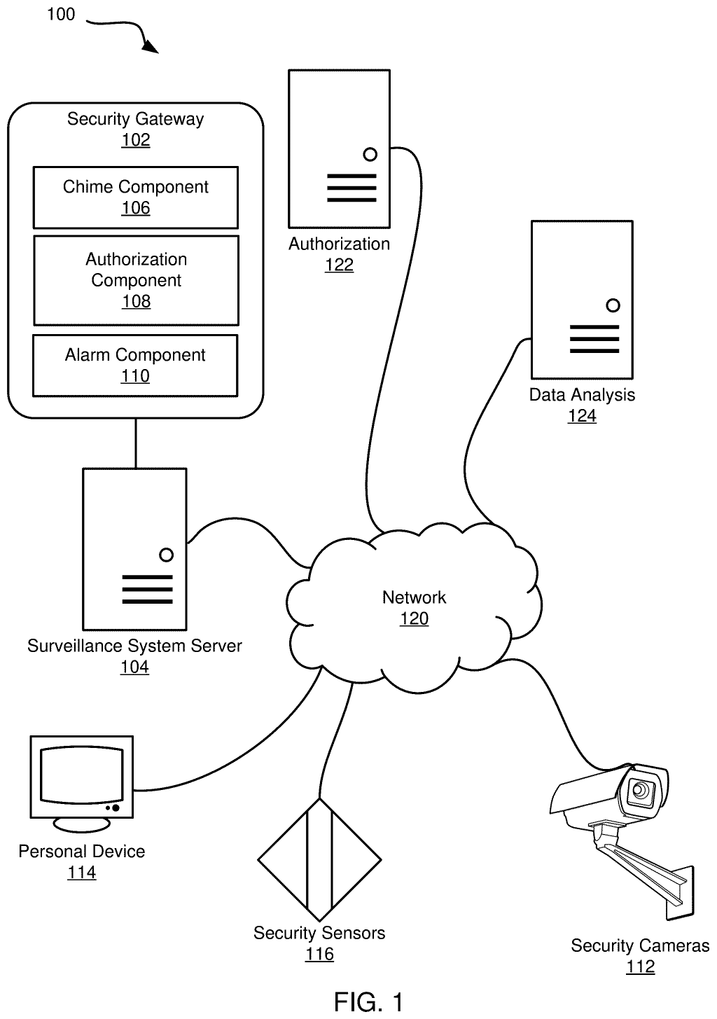

Referring now to the figures, FIG. 1 is a schematic diagram of a system 100 for facilitating communications between components of a security system. The system 100 includes a security gateway 102 executed by a surveillance system server 104 that is in communication with a network 120. Access to the network 120 may be provided onsite at a property, such as a residence, commercial building, land, or other real property, by way of a network connection connected to the surveillance system server 104. The surveillance system server 104 is in communication with one or more personal devices 114 such as smart phones, tablets, mobile phones, laptops, desktop computers, gaming consoles, and so forth. The surveillance system server 104 is additionally in communication with one or more security sensors 116 and one or more components or controllers of security cameras 112.

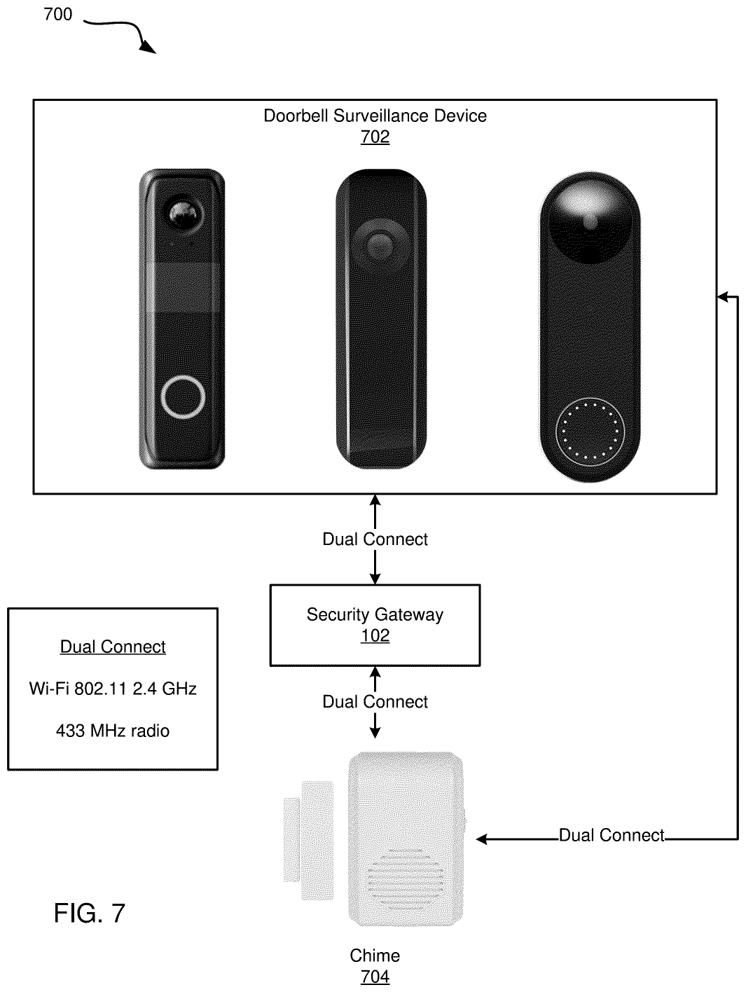

The security cameras 112 include one or more components for visually monitoring a property, including, for example, cameras, network video recorders, digital video recorders, and so forth. The security sensors 116 include additional components for monitoring the property, including, for example, motion sensors, glass break detectors, audio sensors, door sensors, image sensors, light sensors, window sensors, smoke detectors, carbon monoxide detectors, heat sensors, temperature sensors, moisture sensors, water leak sensors, controllers, speakers and so forth. As discussed herein, the security cameras 112 and the security sensors 116 may collectively be referred to herein as the onsite security components 112, 116. The security cameras 112 may specifically include a doorbell surveillance device, such as the doorbell surveillance device 702 first illustrated in FIG. 7.

The onsite security components 112, 116 may be directly or indirectly in communication with the surveillance system server 104 by way of the network 120. The onsite security components 112, 116 include one or more controllers or control panels. The onsite security components 112, 116 may include one or more master control panels (may be referred to as a “controller” as used herein) wherein information applicable to the surveillance system is relayed and processed. The one or more master control panels may each communicate with the network 120 to provide information and data to one or more servers associated with the onsite security components 112, 116. The one or more master control panels may directly communicate with the surveillance system server 104. In an implementation, the onsite security components 112, 116 include a single master control panel, and all surveillance devices (e.g., cameras, sensors, detectors, and so forth) communicate with the single master control panel. In various other implementations, the onsite security components 112, 116 may include a plurality of different master control panels, and different surveillance devices may each communicate with one or more of the plurality of different master control panels.

The surveillance system server 104 communicates with one or more of the controllers associated with the onsite security components 112, 116. In an implementation wherein the onsite security components 112, 116 includes a plurality of different controllers for monitoring and communicating with different surveillance devices, the surveillance system server 104 may communicate with each of the plurality of different controllers. It should be appreciated that the onsite security components 112, 116 may include a single controller for monitoring all surveillance devices, and the surveillance system server 104 may communicate with the single controller.

The controller for the onsite security components 112, 116 and the surveillance system server 104 bidirectionally communicate with one another by way of the network 120. The onsite security components 112, 116 may directly upload data to the surveillance system server 104. Alternatively, the onsite security components 112, 116 may upload data to a third-party surveillance server, and then the third-party surveillance server may communicate with the surveillance system server 104. The onsite security components 112, 116 may provide a real-time notification to the surveillance system server 104 when there is a high likelihood that an intruder or non-authorized individual is present at the property.

The onsite security components 112, 116 may include one or more access control units. Each access control unit may communicate with one or more master control panels. The access control unit includes one or more of a display, a button, a dial, a touch screen, and so forth, such that a user may interact with the access control unit. The access control unit may render a user interface that enables a user to monitor the onsite security components 112, 116, make changes to the onsite security components 112, 116, initiate firmware and software updates for various onsite security components 112, 116, and so forth.

The onsite security components 112, 116 may be independently controlled, managed, and monitored by a third-party surveillance entity. The surveillance system server 104 may communicate with the third-party surveillance entity by way of an Application Program Interface (API) or other communication protocol. The third-party surveillance entity may provide a notification to the surveillance system server 104 when the third-party surveillance entity suspects there is an intruder or non-authorized individual present at the property.

The personal device 114 is any personal computing device that can communicate with the surveillance system server 104, the security cameras 112, and/or the security sensors 116. The personal device 114 may include a smart phone, tablet, laptop, desktop computer, gaming console, smart glasses, web browser, and so forth. Personal devices 114 may communicate with the surveillance system server 104 by way of a local area network (LAN), wide area network (WAN), or another network connection. In an embodiment, personal devices 114 can connect to a network 120, such as a cloud computing network or the Internet, by way of a network connection. The personal device 114 may display a user interface rendered by the surveillance system server 104, the security sensors 116, and/or the security cameras 112. The user interface may enable the user to view data associated with the security sensors 116 and/or the security cameras 112 and may further enable the user to implement settings for automatically actuating one or more components of the security sensors 116 based on data from the security cameras 112.

The system may further include an authorization server 122 in communication with the surveillance system server 104 by way of the network 120. The authorization server 122 may be located offsite at a location that is remote to the property. The authorization server 122 may include a log of authorized persons who are authorized to enter the property. As discussed herein, a “person” may refer to a human being, an animal, a vehicle, a robotic device, or other entity as deemed necessary in the implementation. The log of authorized persons who are authorized to enter the property may include, in one example implementation, persons who live at the property, relatives and/or friends of persons who live at the property, licensed real estate professionals who may provide access to people viewing the property, persons who work at the property, persons with limited-time access to the property, contractors working at the property, and so forth. The log of authorized persons may include an indication of specific dates, times, or durations of time that each of the persons is authorized to enter the property.

The authorization server 122 may be in communication with a network 120 such as a cloud computing network. In an embodiment, the surveillance system server 104 is in communication with the authorization server 122 by way of the network 120 such that new profiles of authorized persons may be uploaded from the authorization server 122 to the surveillance system server 104. In an embodiment, a single server includes the information stored in the authorization server 122 and the surveillance system server 104. In an embodiment, the information stored in the authorization server 122 includes sensitive information such as personally identifiable information, and the information is therefore encrypted and safeguarded.

The system may further include a data analysis server 124 in communication with (or incorporated within) the surveillance system server 104. The data analysis server 124 includes processing and storage requirements for performing real-time data analysis on data captured by the security cameras 112. The data analysis server 124 receives data directly from the security cameras 112 and/or indirectly by way of the surveillance system server 104. The data analysis server 124 performs real-time analysis of images, videos, audio recordings, noise sensor outputs, moisture sensor outputs, door sensor outputs, window sensor outputs, motion sensor outputs, and so forth. The data analysis server 124 determines whether a person has tripped the security cameras 112, for example, by opening a door or window when the security cameras 112 is armed, or by being captured by a camera, motion sensor, or audio sensor located on the property. The data analysis server 124 further determines an identity of a person captured in an image or video stream captured by the security cameras 112.

The data analysis server 124 includes an image analysis component that is executed by a neural network or machine learning algorithm. The image analysis component executes facial recognition algorithms on images and video streams captured by the security cameras 112. The image analysis component calculates a confidence score that an image likely depicts a known person who is authorized to enter the property. The data analysis server 124 may communicate with the authorization server 112 to receive one or more images of each person on the log of authorized persons. The image analysis component will become increasingly accurate and efficient at identifying authorized persons as the security cameras 112 continues to capture images of the authorized persons, and those images are fed to the image analysis neural network.

The security gateway 102 includes one or more of a chime component 106, an authorization component 108, and an alarm component 110. The security gateway 102 may include further components and may be configured to perform additional instructions.

The chime component 106 of the security gateway 102 communicates with a chime within a surveillance system. The surveillance system may include one or more chimes (see chime 704 first illustrated in FIG. 7) that comprise a speaker and are configured to emit an auditory notification. The chime may be configured with different auditory notifications such that the chime may serve as a doorbell, an intruder alarm, a smoke alarm, a toxic chemical alarm, a water leak alarm, and so forth. The chime may include a speaker capable of emitting sounds in excess of 80 dB in some implementations. The chime may additionally include one or more lights and may be configured to emit or pulse a light-based notification or “illumination notification.” In some implementations a security gateway 102 may be integrated with a home notification device such as a doorbell together with or in place of a chime component 106 as shown in FIG. 1.

The chime component 106 instructs the chime to emit an auditory notification. The chime component 106 may instruct the chime to emit a loud auditory alarm when the surveillance system server 104 determines that an intruder is present at the property. The surveillance system server 104 may make this determination based on output from the data analysis server 124 and/or data received from any of the security sensors 116 and/or security cameras 112.

The chime component 106 may instruct the chime to emit a non-security alarm or other notification in response to other events. In an implementation, the chime component 106 instructs the chime to emit an auditory notification and/or illumination notification when one or more security components 112, 116 of the system 100 go offline or otherwise discontinue communications with the surveillance system server 104. The chime component 106 may instruct the chime to emit an auditory notification and/or illumination notification when a security sensor 116 and/or security camera 112 determines that a person is present at a door of the building.

The authorization component 108 of the security gateway 102 determines whether a person is authorized to be present at the property. The authorization component 108 receives data from the security cameras 112, including, for example, images, video streams, audio recordings, motions sensor data, and so forth. The authorization component 108 communicates with the data analysis server 124 (in an embodiment, the data analysis server 124 is a component of the authorization component 108) to identify objects of interest within the data captured by the security cameras 112. The authorization component 108 determines whether any of the objects of interest captured by the security cameras 112 have been pre-authorized to be present at the property.

If the data captured by the security cameras 112 includes an image, the data analysis server 124 executes a machine learning algorithm to identify one or more objects of interest within the image such as persons, animals, vehicles, and so forth (each of these categories may be generically referred to as a “person” herein). The data analysis server 124 draws a bounding box around each object of interest and then performs further analysis on the image data within the bounding box. The data analysis server 124 executes a facial recognition machine learning algorithm to calculate a confidence score for a predicted identity of each object of interest within the image. The data analysis server 124 compares image data for the objects of interest captured by the security cameras 112 with stored image data received from the authorization server 122. The data analysis server 124 calculates a confidence score that a person depicted in data captured by the security cameras 112 is the same person that has been pre-authorized to be at the property according to the log of authorized persons stored on the authorization server 122.

The authorization component 108 refers to the log of authorized persons stored on the authorization server 122 to determine whether a person at the property is authorized. If the person is authorized to be at the property, the authorization component 108 may send a notification to a user associated with the security gateway 102 and request the user to confirm whether the person is authorized to be located at the property. If the person is not authorized to be at the property, the authorization component 108 may automatically generate a notification indicating that the chime component 106 should cause one or more components of the security sensors 116 to open. If the person is not authorized to be at the property, the authorization component 108 may send a notification to a user associated with the security gateway 102 and request the user to confirm whether the person is not authorized to be located at the property and may further request the user to indicate whether any component of the security sensors 116 should be actuated.

The alarm component 110 of the security gateway 102 may activate one or more alarms or notifications in response to a non-authorized person entering the property. The alarm component 110 may ensure that sensors remain active while the non-authorized person is at the property and may further activate one or more noise-emitting alarms, notifications to law enforcement, notifications to monitoring agencies, and so forth, while the non-authorized person is at the property. The alarm component 110 may trigger a notification to be sent to the property manager or property owner indicating that a non-authorized person has entered the property. The alarm component 110 may activate an alarm indicating that the one or more components of the security sensors 116 have been actuated directly in response to the non-authorized person being on the property.

The surveillance system server 104 provides access to the security gateway 102 to security sensors 116, onsite surveillance systems 112, and/or personal devices 114. The surveillance system server 104 may serve as a dedicated server group to support the security gateway 102 for all devices (see 112, 114, 116) interacting with the security gateway 102.

In an embodiment as illustrated in FIG. 1, the surveillance system server 104 is independent of the authorization server 122, the data analysis server 124, and the sensor monitoring server 126. This may be desirable in an instance where the security gateway 102 connects to a third-party server or database that comprises user profile information for authorized persons, instructions for executing machine learning algorithms for data analysis, and so forth. For example, a third-party service might exist that catalogs user profile information for numerous retail establishments. The security gateway 102 may connect with such a third-party service to obtain user profile information. The security gateway 102 may receive user profile information from a third-party user profile service by way of the authorization server 122.

In an embodiment (not shown in FIG. 1), the surveillance system server 104 and any one of the authorization server 122, the data analysis server 124, and the sensor monitoring server 126 are not independent of one another. In such an embodiment, a single server group may include all information necessary for running the security gateway 102, including user profile information, payment information, transaction history, data analysis algorithms, and so forth. It should be appreciated that numerous different configurations may be used without departing from the scope of the disclosure.

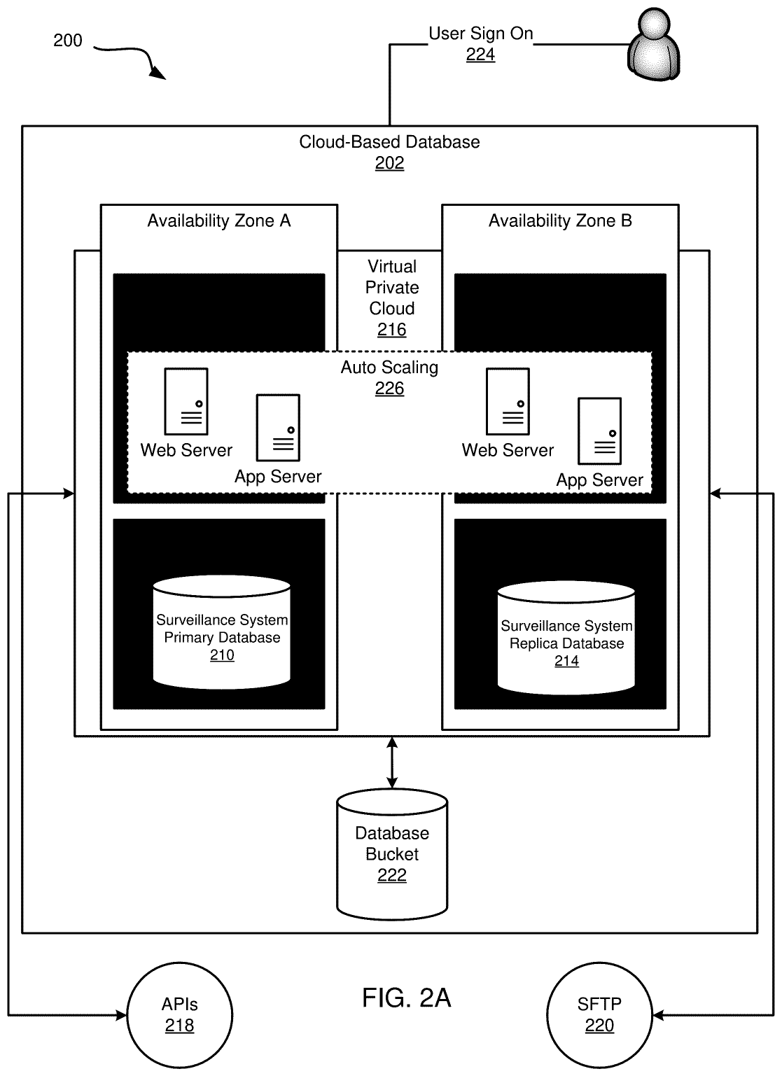

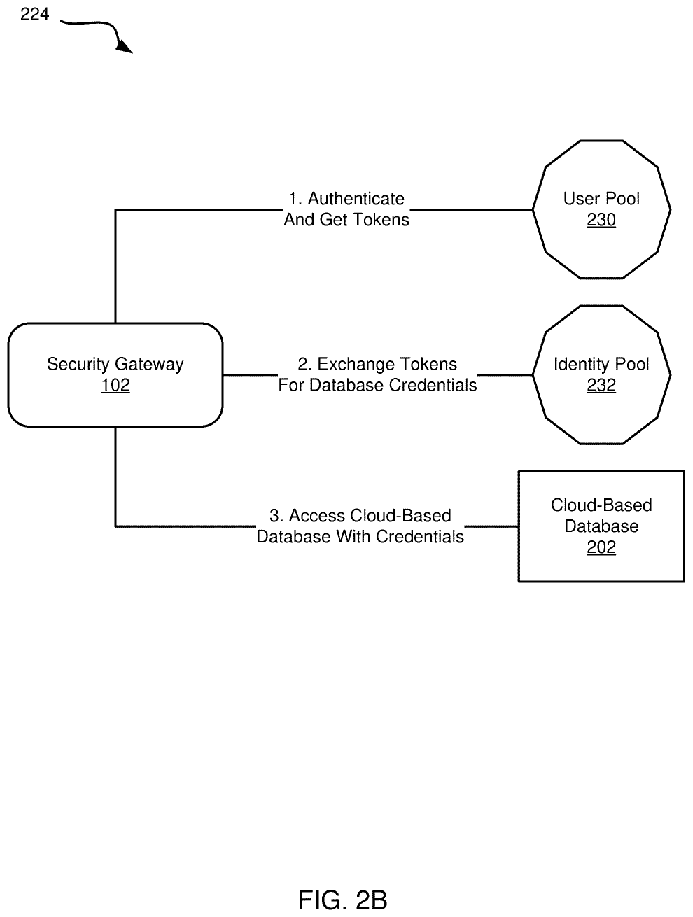

FIG. 2A is a schematic block diagram of a system 200 for facilitating communications between a plumbing system and an onsite surveillance system. The system 200 illustrated in FIG. 2A may be implemented in conjunction with the system 100 illustrated in FIG. 1. The system 200 includes a cloud-based database 202 supporting the surveillance system server 104. The cloud-based database 202 includes an Availability Zone A and an Availability Zone B. The Availability Zone A includes a first instance of the surveillance system server 104 and the Availability Zone B includes another instance of the surveillance system server 104. Each of the instances of the surveillance system server 104 includes a web server and an app server, and the cloud-based database 202 auto-scales the processing and storage resources between the web servers and app servers for the Availability Zone A and the Availability Zone B. The Availability Zone A includes a primary relational database service (RDS) 208 and the Availability Zone B includes a replica relational database service 212. The surveillance system primary database 210 is stored on the primary relational database service 208 and the surveillance system replica database 214 is stored on the replica relational database service 212. The virtual private cloud 216 of the cloud-based database 202 communicates with outside parties by way of Application Program Interfaces 218 and Secure File Transfer Protocol (SFTP) 220 messaging. The cloud-based database 202 includes a database bucket 222 for storing information associated with the security gateway 102. Users interacting the security gateway 102 can sign on 224 to the service by communicating with the cloud-based database 202.

The cloud-based database 202 includes processing and storage resources in communication with the network 120. The cloud-based database 202 includes a resource manager for managing the usage of processing and storage resources. The resource manager of the cloud-based database 202 performs auto scaling 226 load balancing to ensure adequate processing and storage resources are available on demand based on real-time usage.

The availability zones represent discrete datacenters with redundant power, networking, and connectivity for supporting the surveillance system server 104. The availability zones enable the ability to operate production applications and databases in a more highly available, fault tolerant, and scalable way than would be possible with a single datacenter. The Availability Zone A and Availability Zone B are interconnected with high-bandwidth, low-latency networking, over fully redundant, dedicated metro fiber providing high-throughput, low-latency networking between the availability zones. All traffic between the availability zones is encrypted. The network performance of the availability zones is sufficient to accomplish synchronous replication between the availability zones. Applications, modules, components, and processing methods can be partitioned between the availability zones of the cloud-based database 202. When applications are partitioned across the availability zones, the surveillance system server 104 operates with increased protection and isolation from outages that may be caused by a low in power, hardware issues, software issues, and so forth. The availability zones are physically separated by a meaningful geographic distance to ensure the hardware supporting the availability zones will not be impacted by the same outside forces, such as power outages, natural disasters, and so forth.

The virtual private cloud 216 is an on-demand configurable pool of shared resources allocated within the cloud-based database 202. The virtual private cloud 216 provides isolation between different users communicating with the cloud-based database 202, e.g., different facilities, user accounts, and clients in communication with the security gateway 102. The isolation between one virtual private cloud 216 user and all other users of the same cloud is achieved through allocation of a private IP subnet and a virtual communication construction such as a VLAN or a set of encrypted communication channels per user. The virtual private cloud 216 provides isolation between users within the cloud-based database 202 and is accompanied with a VPN function allocated per-user within the virtual private cloud 216. This secures the remote access to the security gateway 102 by way of authentication and encryption. The security gateway 102 is then essential run on a “virtually private” cloud, even if the processing and storage resources are provided by a third-party cloud-based database service, such as Amazon Web Services®.

The auto-scaling 226 is performed by a resource manager of the cloud-based database 202. The resource manager distributes workload between the web servers and the app servers of the various availability zones of the cloud-based database 202. In some cases, one client of the security gateway 102 may consume a large quantity of storage resources and processing resources at a certain time, and the resource manager will allocate different web servers and app servers across the availability zones to ensure the client receives an adequate quantity of storage and processing resources. The auto-scaling 226 is performed in real-time to meet the needs of the security gateway 102.

The primary and secondary relational database services 208, 212 provide a means to access, replicate, query, and write to the surveillance system database instances 210, 214. The surveillance system primary database 210 may include a copy of data associated with the security gateway 102. The surveillance system replica database 214 may include a replica copy of all or some of the data stored on the surveillance system primary database 210. The replicated databases provide fault-tolerance and protect the security gateway 102 from becoming inoperative during a power outage, hardware outage, or natural disaster.

The database bucket 222 provides object storage through a web service interface. The database bucket 222 uses scalable storage infrastructure that can be employed to store any type of object. The database bucket 222 may store applications, software code, backup and recovery, disaster recovery, data archives, data lakes for analytics, and hybrid cloud storage to support the security gateway 102.

FIG. 2B is a schematic block diagram of a system and process flow for accessing the cloud-based database 202 described in FIG. 2A. The security gateway 102 first authenticates and retrieves tokens from a user pool 230. The security gateway 102 then exchanges tokens for database credentials with the identity pool 232. The security gateway 102 is then granted access to the could-based database 202 based upon the credentials.

The user pool 230 is a user directory associated with the cloud-based database 202. With the user pool 230, users can sign into the security gateway 102 through a mobile application, computer-based application, web-based user interface, third-party identity provider, and so forth. Whether users sign in directly or through a third party, all members of the user pool 230 have a director profile that can be accessed. The user pool 230 enables sign-up and sign-in services for the security gateway 102 and further enables social sign-in with outside services, including outside social media networks. The user pool 230 stores a directory, and this directory may be managed, and permissions may be assigned to users within the director.

The identity pool 232 creates temporary credentials to access the cloud-based database 202. The identity pool 232 supports anonymous guest users and social sign-in through outside parties, including third-party social media network.

The system 200 authenticates users by leveraging the user pool 230. After a successful sign-in through the user pool 230, the security gateway 102 creates user pool groups to manage permissions and to represent different types of users. The security gateway 102 creates user groups defined by a type of data permission for that group.

The security gateway 102 may access the cloud-based database 202 through an Application Program Interface (API) Gateway. The API Gateway validates the tokens from a successful user pool 230 authentication and uses those tokens to grant users access to the resources within the security gateway 102 and the cloud-based database 202. The security gateway 102 leverages the user groups defined within the user pool 230 to control permissions with the API Gateway by mapping group membership to roles within the user pool 230. The user groups that a user is a member of are included in the identification token provided by a user pool 230 when the user signs into the security gateway 102. The security gateway 102 submits the user pool tokens with a request to the API Gateway for verification by an authorizer for the cloud-based database 202.

In an embodiment, a unique user pool 230 is created for each tenant within the security gateway 102. This approach provides maximum isolation for each tenant and allows the security gateway 102 to implement different configurations for each tenant. Tenant isolation by user pool 230 allows flexibility in user-to-tenant mapping and allows multiple profiles for the same user. Additionally, in this implementation, a unique hosted user interface may be assigned to each tenant independently, and the security gateway 102 will automatically redirect each tenant to their tenant-specific user interface instance.

In an embodiment, a single user may be mapped to multiple tenants without recreating the user's profile within the security gateway 102. In this embodiment, a data package client is executed for each tenant, and this data package client enables the tenant external IdP as the only allowed provider for that data package client. Data package client-based multi-tenancy requires additional considerations for username, password, and more to authenticate users with the native accounts. When the hosted user interface is in use, a session cookie is created to maintain the session for the authenticated user. The session cookie also provides SSO between data package clients in the same user pool 230.

In an embodiment, the security gateway 102 implements role-based access control. The identity pools 232 assign authenticated users a set of temporary, limited-privilege credentials to access the resources in the cloud-based database 202. The permissions for each user are controlled through roles created within the security gateway 102. The security gateway 102 defines rules to choose the role for each user based on claims in the user's identification token. The rules enable the security gateway 102 to map claims from an identity provider token to a role. Each rule specifies a token claim (such as a user attribute in the identification token from the user pool 230), match type, a value, and a role. The match type can be Equals, NotEqual, StartsWith, or Contains. If a user has a matching value for the claim, the user can assume that role when the user gets credentials. For example, the security gateway 102 may create a rule that assigns a specific role for the users with a custom:dept custom attribute value of Sales.

Rules are evaluated in order, and the role for the first matching rule is used, unless a custom role is specified to override the order. The security gateway 102 may set multiple rules for an authentication provider in the identity pool 232. Rules are applied in order. The order of the rules may be altered. The first matching rule takes precedence. If the match type is NotEqual, and the claim does not exist, then the rule is not evaluated. If no rules match, the role resolution setting is applied to either use the default authenticated role or to deny. The security gateway 102 specifies a role within the API connection to the cloud-based database 202 to be assigned when no rules match in the ambiguous role resolution process. For each user pool 230 or other authentication provider configured for an identity pool 232, the security gateway 102 may assign numerous rules.

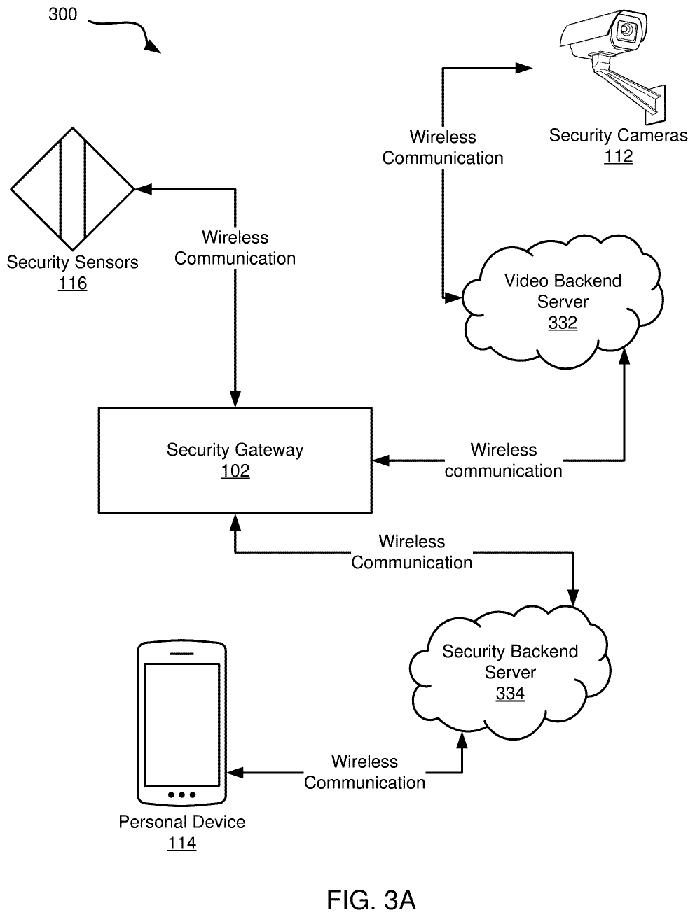

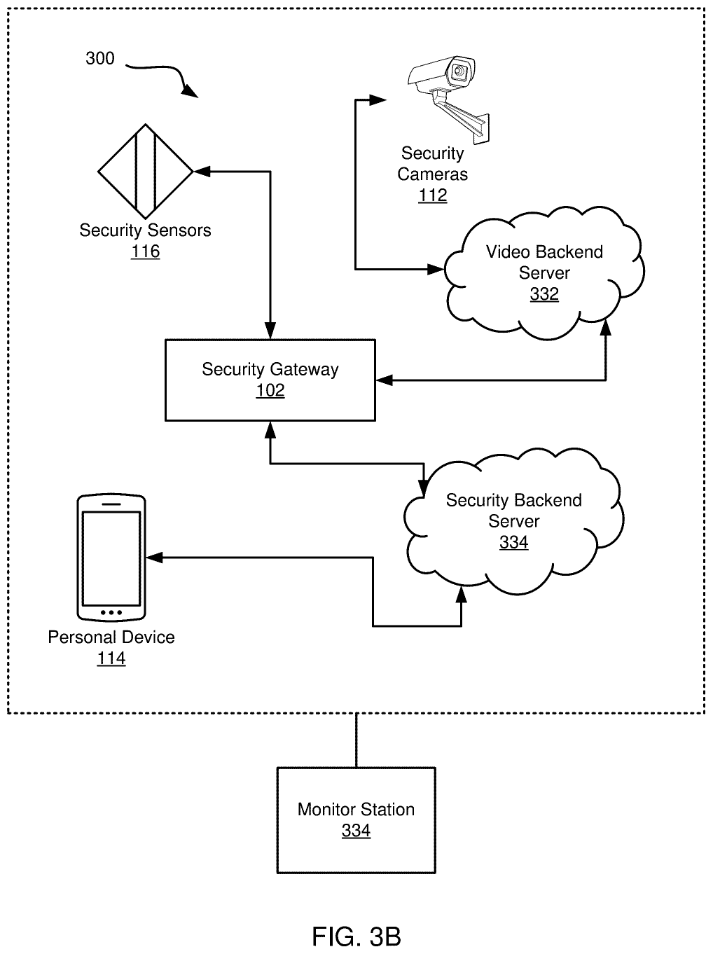

FIGS. 3A and 3B illustrate schematic diagrams of a system 300 for facilitating communications between components of a surveillance system. The system 300 includes a security gateway 102 in communication with the security cameras 112, personal devices 114, and security sensors 116 by way of a wireless communication protocol. The communications between the personal devices 114 and the security gateway 102 are routed through a security backend server 334. The communications between the security cameras 12 and the security gateway 102 are routed through a video backend server 332. FIG. 3B illustrates wherein the system 300 wholistically communicates with a monitor station 334.

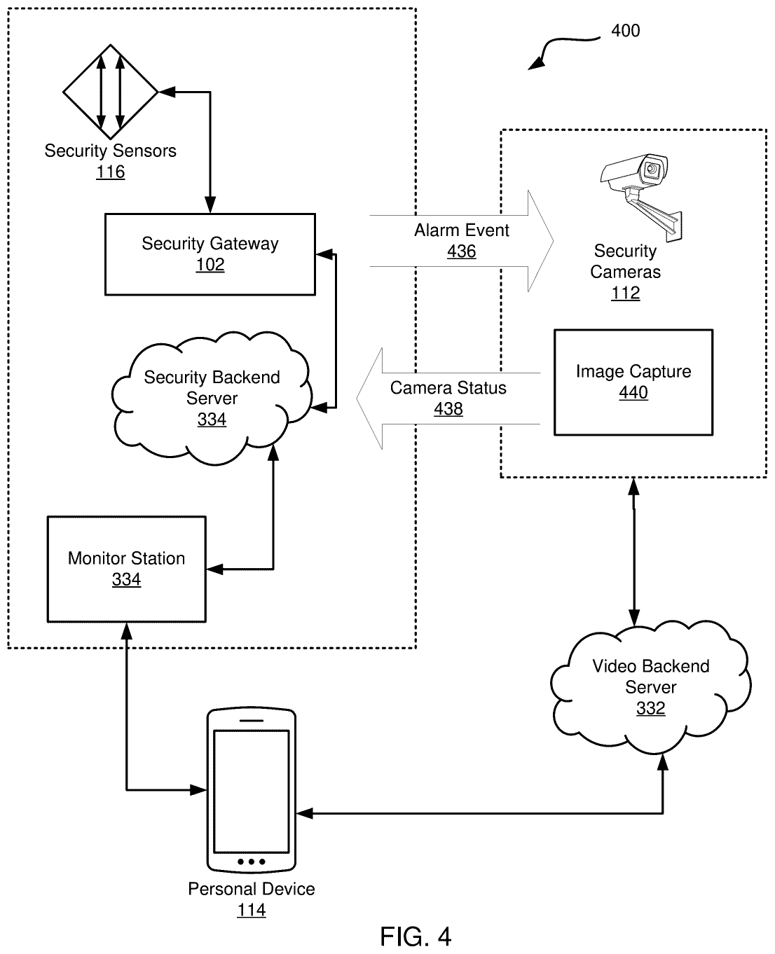

FIG. 4 illustrates a schematic diagram of a system 400 for facilitating alarm event communications between onsite surveillance components 112, 116 and a personal device 114. In an implementation, an alarm event 436 occurs. The alarm event 436 may be triggered by a user manually triggering the surveillance system and/or by a security sensor 116 triggering the alarm event 436. When the alarm event 436 occurs, the security gateway 102 may enter a duress mode and arm the surveillance system. The security gateway 102 communicates with the security cameras 112 to retrieve visual surveillance data. The security cameras 112 execute an image capture 440 operation and provide camera status 438 back to the security gateway 102.

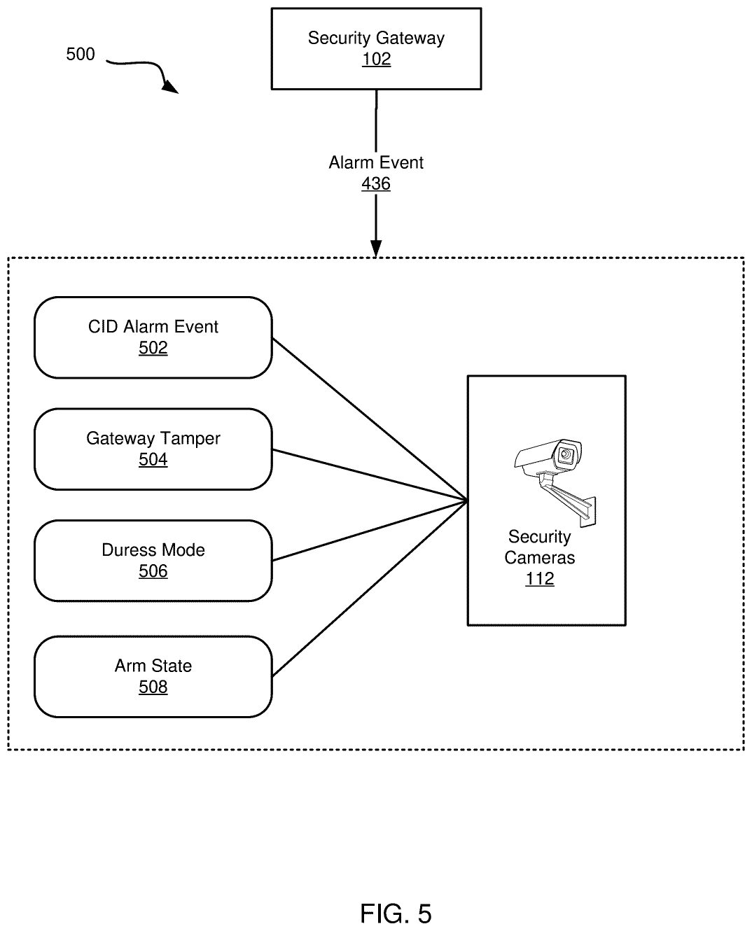

FIG. 5 is a schematic diagram illustrating camera activity when the security cameras 112 receive an alarm event 436 from the security gateway 102. The security cameras 112 may receive the alarm event 436 in response to a CID alarm event 502, gateway tamper 504 event, duress mode 506 activation, and/or activation of the arm state 508. When the security cameras 112 are notified of the alarm event 436, one or more of the security cameras 112 will capture visualization data and upload the data to the video backend server 332. One or more alarms within the surveillance system may illuminate and play and alarm sound when the alarm event 436 message is received.

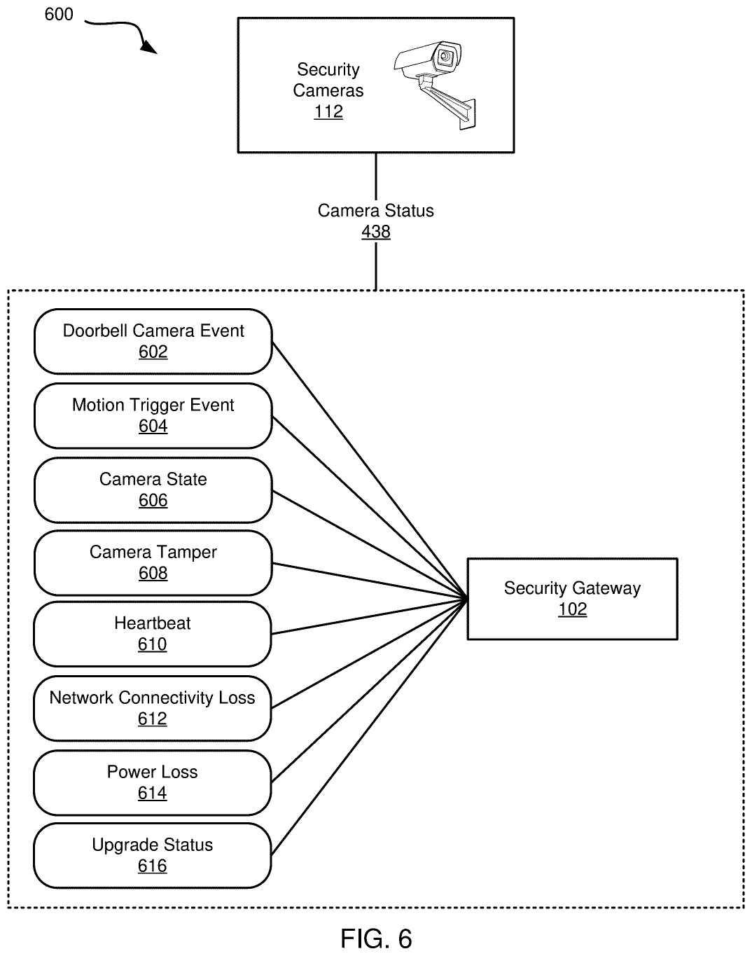

FIG. 6 is a schematic diagram illustrating security gateway activity when the security gateway 102 receives a camera status 438 event from one or more of the security cameras 112. The camera status event may include one or more of a doorbell camera event 602, a motion trigger event 604, a camera state 606 indication, an indication that a camera has been tempered with 608, a heartbeat 610 event, a network connectivity loss 612 for one or more devices, a power loss 614 for one or more devices, or an upgrade status 616.

The security gateway 102 may cause a chime device to emit a chime tone when receiving the camera status 438 form the security camera 112. The security gateway 102 may activate an emergency event and/or output an error message in response to receiving one or more of the camera status events 602-616.

FIG. 7 is a schematic diagram illustrating a system 700 for facilitating communications between a doorbell surveillance device 702 and a chime 704. The doorbell surveillance device 702 may communicate directly with the chime 704 and/or may communicate with the chime 704 by way of the security gateway 102.

The doorbell surveillance device 702 comprises one or more sensors and may replace or supplement a traditional doorbell. The doorbell surveillance device 702 may replace a traditional doorbell and receive hardwired power from the same power hookups for the traditional doorbell. The doorbell surveillance device 702 may include a camera, microphone, speaker, motion sensor, and other associated sensors. In the implementation shown in FIG. 7, the chime 704 may comprise a speaker and is configured to emit an audio notification, which may include an alarm, doorbell sound, or other notification. The chime 704 may additionally include one or more lights and may be configured to illuminate at certain times. In other implementations the chime 704 may instead be a home notification device such as a doorbell configured to interact with a doorbell surveillance device 702 and system 700. In such implementations, the doorbell may feature additional circuitry in order to effectively interface with the doorbell surveillance device 702 and other components in the system 700.

The doorbell surveillance device 702 communicates with the security gateway 102 and/or the chime 704 by way of two connection protocols. The doorbell surveillance device 702 is capable of connecting to a local Wi-Fi® network and is additionally capable of communicating by way of a radio frequency band. The doorbell surveillance device 702 may communicate by way of Wi-Fi® on a 2.4 GHz and/or 5 GHz band. The doorbell surveillance device 702 may specifically connect to Wi-Fi® by way of an 802.11 IEEE (Institute of Electrical and Electronic Engineers) standard for a LAN (local area network) connection to the network. The doorbell surveillance device 702 is additionally capable of communicating by way of a wireless radio band, such as a 433 MHz band. Thus, the doorbell surveillance device 702 has at least two means of communicating with the security gateway 102 and/or chime 704.

The chime 704 may communicate with the security gateway 102 and/or the doorbell surveillance device 702 through the same communication protocols, including the Wi-Fi® connection and/or the wireless radio frequency band. Thus, each of the doorbell surveillance device 702 and the chime 704 have a backup communication protocol if the device experiences a network connectivity loss. The other security cameras 112 and security sensors 116 described herein may also be equipped with the dual connectivity described in connection with the doorbell surveillance device 702 and the chime 704.

The doorbell security device 702 may activate an alarm that plays through the chime 704 at a remote location. In an implementation, the doorbell security device 702 is installed outside near the front door of a building, in a traditional doorbell location. The chime 704 may be located indoors and/or outdoors at the same building and configured to emit an audio notification in response to receiving data from the doorbell security device 702. In some cases, the doorbell security device 702 cannot be configured to play audio through an existing doorbell speaker that may already be installed at the building. In these cases, users may rely on the chime 704 to be notified when someone is present at the door. The chime 704 may further be used to provide audio notifications at different areas within the building, including regions where it is difficult to hear an existing doorbell speaker. A single doorbell security device 702 may be in communication with one or more chimes 704. Additionally, a single chime 704 may emit audio notifications for one or more different doorbell security devices 702.

The doorbell security device 702 may be hardwired to draw power from the building's electrical system. Alternatively, the doorbell security device 702 may rely on battery power. In some implementations, the doorbell security device 702 primarily draws power from the building's electrical system and maintains battery power for backup situations.

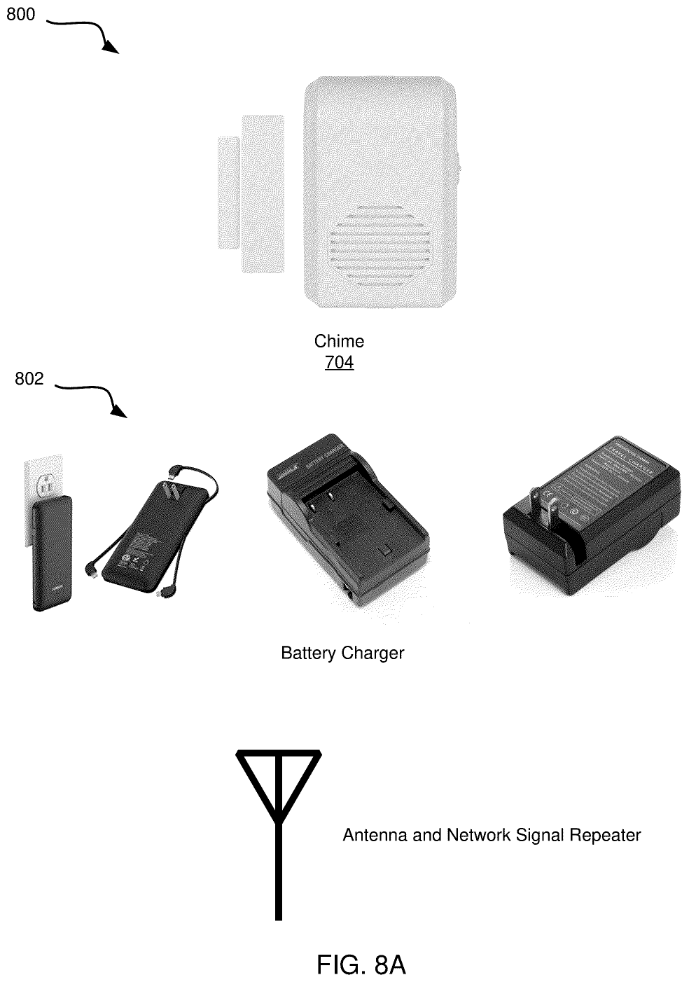

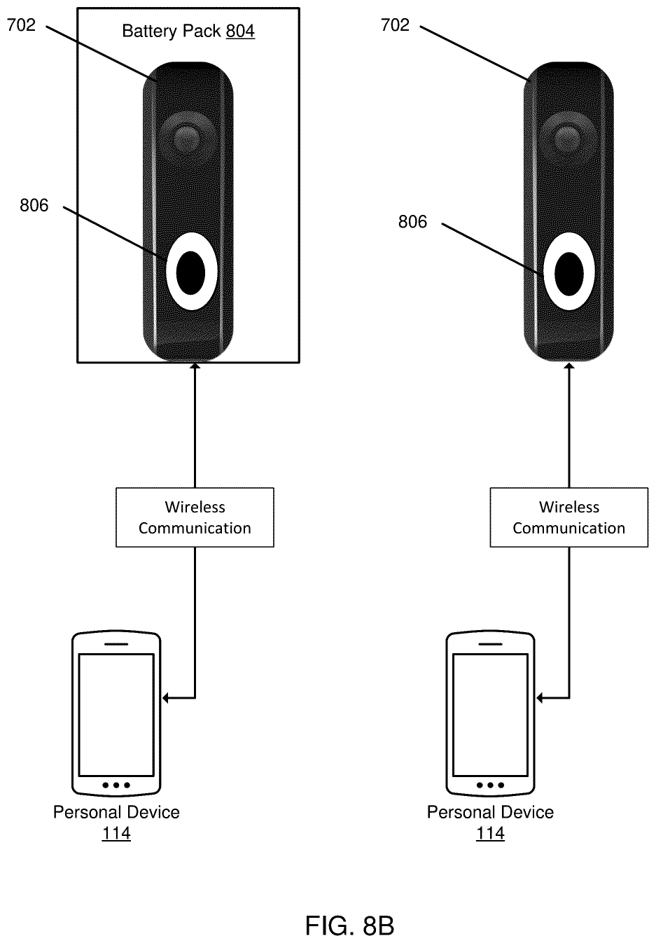

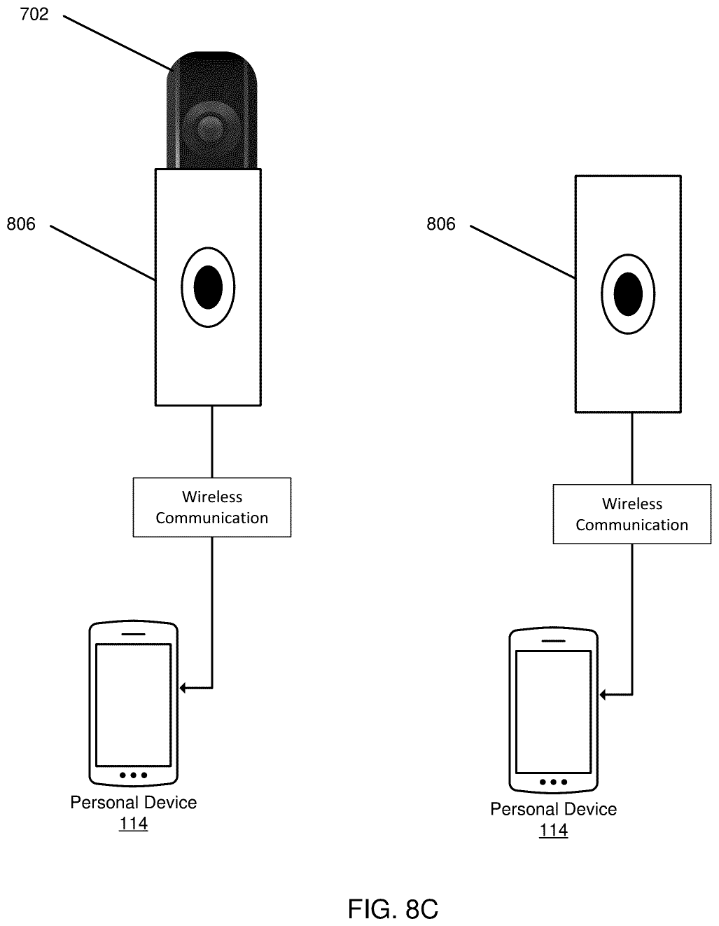

FIG. 8A illustrates components of a chime charger 800. The chime charger 800 includes a chime 704 comprising a speaker for emitting an auditory notification. The chime charger 800 is configured to be plugged into an outlet anywhere inside or outside of a building. The chime charger 800 may draw electricity from the outlet to charge a secondary battery for the doorbell surveillance device 702. Thus, the chime charger 800 serves as a chime 702 in communication with the doorbell surveillance device 702, and additionally serves as a means to charge a battery for the doorbell surveillance device 702. This ensures that a user always has a working battery for the doorbell surveillance device 702.

In some cases, it is important to ensure the doorbell surveillance device 702 may operate with backup battery power. An intruder may immediately seek to cut power to the surveillance system and/or the entire building. If this occurs, the doorbell surveillance device 702 will turn off if the doorbell surveillance device 702 is not equipped with a battery backup. When the doorbell surveillance device 702 is equipped with a battery backup, the doorbell surveillance device 702 may continue to communicate with the security gateway 102 and/or the chime 704 when power is cut to the building. The doorbell surveillance device 702 may then instruct the chime 704 to emit an alarm, which may deter the intruder from remaining in the building and may signal to the intruder that the surveillance system is still active.

The chime 704 may be configured with its own battery backup and may additionally be configured to charge a secondary battery for the doorbell surveillance device 702. The secondary battery for the doorbell surveillance device 702 may receive charge from the chime 704 by way of the wall outlet where the chime 704 is stored and connected. A user may quickly swap between two or more batteries for the doorbell surveillance device 702 to ensure that one battery is always installed in the doorbell surveillance device 702 with sufficient charge to power the doorbell surveillance device 702, and further to ensure that one or more secondary batteries are charging on a chime charger 800.

The chime charger 800 may draw power directly from an outlet. Additionally, the chime charger 800 may include an external power device 802. An external power device 802 may be a battery backup installed therein that automatically charges itself from the outlet power. The external power device may interface with a chime 704 or doorbell surveillance device 702 in a number of ways according to the implementation. For example, the external power device 802 may have one or more contacts to provide wireless charging to the doorbell surveillance device 702 or chime 704. In some implementations the doorbell surveillance device 702 or chime 704 may interface with an external power device via male/female connectors, such as a USB plug/outlet interface, in order to provide a redundant power source to the doorbell surveillance device 702. The male end may be located on one of the doorbell surveillance device 702 or chime 704 and the female end on the external power device 802, or vice versa depending on the implementation. Thus, power to the outlet could be disconnected, and/or the chime charger 800 could be removed from the outlet, and the chime charger 800 could continue to emit an alarm and/or communicate with the security gateway 102 and/or the doorbell surveillance device 702.

FIG. 8B shows implementations of a chime charger utilizing an external power device according to the principles of the present disclosure. In a nonlimiting example, the door surveillance device 702 may interface with an external power device 804, exemplified in this figure as a battery pack. The door surveillance device may also double as a chime or other notification device as in 704, having a speaker and/or button 806 in order to provide camera and notification functionality in an integrated device. As described in FIG. 8A, the external power device 804 may interface with the door surveillance device in a variety of ways. In addition to wireless contacts or plugs, the door surveillance device 702 and external power device 804 may slidably interact in order to interface. A door surveillance device may be configured to have a cavity or protrusion that an external power device 804 may interact with in order to attach and secure to the doorbell surveillance device 702. Also shown in FIG. 8B, the external power device 804 may be removed and the doorbell surveillance device 702 may continue to function by providing wireless communication to a personal device 114 as seen in FIG. 1. In some implementations an external power device may provide charge to an internal battery within a doorbell surveillance device 702, while in others the external power device may provide a secondary power source in the event the doorbell surveillance device 702 loses a primary power source.

FIG. 8C shows yet another implementation wherein the doorbell surveillance device 702 interacts with a home notification device. In this implementation, the integrated doorbell surveillance device 702 includes a power source within and may interface with a home notification device 806 integrated with the system 700 (as in FIG. 7), such as a doorbell. If the doorbell surveillance device 702 featuring the camera is removed, the home notification device 806 may still retain networking capability with the overall system (700, seen in FIG. 7) independently of the doorbell surveillance device 702 and be able to communicate wirelessly with a personal device 114. Thus, while the doorbell surveillance device 702 featuring the camera may be removed in order to charge or for other reasons, a user may still have security capabilities by receiving notifications to a personal device 114 via the home notification device 806 integrated with the system 700.

The chime charger 800 additionally serves as a Wi-Fi® extender or repeater. The chime charger 800 may thereby boost the Wi-Fi® signal and enable the doorbell surveillance device 702 and/or other devices on the Wi-Fi® network to receive a strong connection to the network.

The chime 704 and chime charger 800 may include a loud siren to ward off intruders and/or alert users present within the building. The siren may emit audio notifications in excess of 85 dB in some implementations.

The chime charger 800 additionally includes a network signal repeater for boosting a network signal. The chime charger 800 may include dual connectivity such that the chime 704 includes a wireless antenna for transmitting and receiving communications over a Wi-Fi® network protocol, such as an 802.11 protocol with a 2.4 GHz band. The chime 704 may additionally include a radiofrequency antenna such that the chime 704 may communicate with a radiofrequency signal when the Wi-Fi® network connection is lost. Additionally, the chime charger 800 serves as a network signal repeater and boosts the Wi-Fi® network signal. This may enable other onsite surveillance devices 112, 116 to receive a stronger connection to the Wi-Fir® network signal.

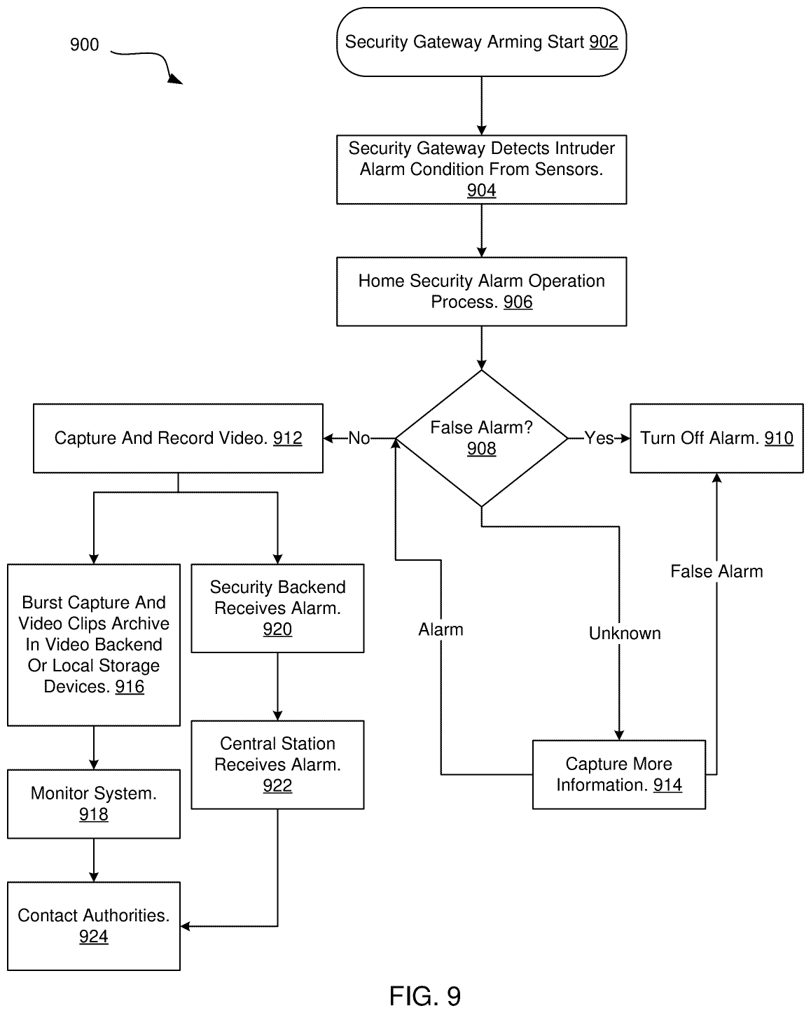

FIG. 9 is a schematic flow chart diagram of a method 900 for an alarm process. The method 900 includes the security gateway 102 arming at 902. The security gateway 102 detects an intruder at 904 based on sensor data. The sensor data might include camera data from a doorbell camera, camera data from a camera installed interior or exterior to the property, a door sensor, a glass break sensor, a window sensor, an infrared motion detection sensor, a microphone, and so forth. The security gateway 102 then initiates the home security alarm operation process at 906.

The home security alarm operation process 906 includes determining at 908 whether the sensor data is triggering a false alarm. This determination may be made based on the quality of the sensor data and/or the content of the sensor data. In some cases, the security gateway 102 provides the sensor data to a server equipped with a neural network configured to assess the sensor data and determine whether it constitutes a false alarm. If the security gateway 102 determines that the sensor data likely indicates a false alarm, then the security gateway turns off the alarm at 910. If the security gateway 102 is unsure if the sensor data indicates a false alarm, then the security gateway 102 causes other sensors to capture more information at 914, and if the additional information indicates a false alarm, then the security gateway 102 turns off the alarm at 910.

If the security gateway 102 doe does not determine that the sensor data indicates a false alarm at 902, then the security gateway 102 instructs one or more cameras to capture and record video at 912. The one or more cameras may be selected based on proximity to the sensor that initially provided the sensor data indicating an alarm condition at 904. The one or more cameras may include a doorbell camera, cameras installed interior to the property, cameras installed exterior to the property, and so forth. The cameras burst capture video clips and archive the video clips in video backend or local storage devices at 916. The security gateway 102 monitors the system at 918 and contacts authorities (e.g., emergency services) at 924 as needed. The security backend receives the alarm at 920 and a central station may receive the alarm at 922.

The method may be triggered at 904 by various types of sensor data. In an example implementation, the property is equipped with a smoke sensor in communication with the security gateway 102. The smoke sensor may provide data to the security gateway 102 at 904 indicating that smoke is detected at the property. The security gateway 102 may then instruct one or more cameras located near the smoke sensor to capture a series of images. This series of images may be assessed to determine whether there is smoke and/or a fire at the property.

In another example implementation, the property is equipped with an egress sensor such as a door sensor, glass break sensor, or window sensor. The egress sensor may provide an alarm event to the security gateway 102 at 904 indicating that a door has been opened, glass has been broken, or a window has been opened. The security gateway 102 may then instruct one or more cameras with an eyeline to the egress sensor to immediately start capturing real-time images of the region near the egress sensor. The security gateway 102 and/or server may then assess the images to determine whether there is an intruder at the property.

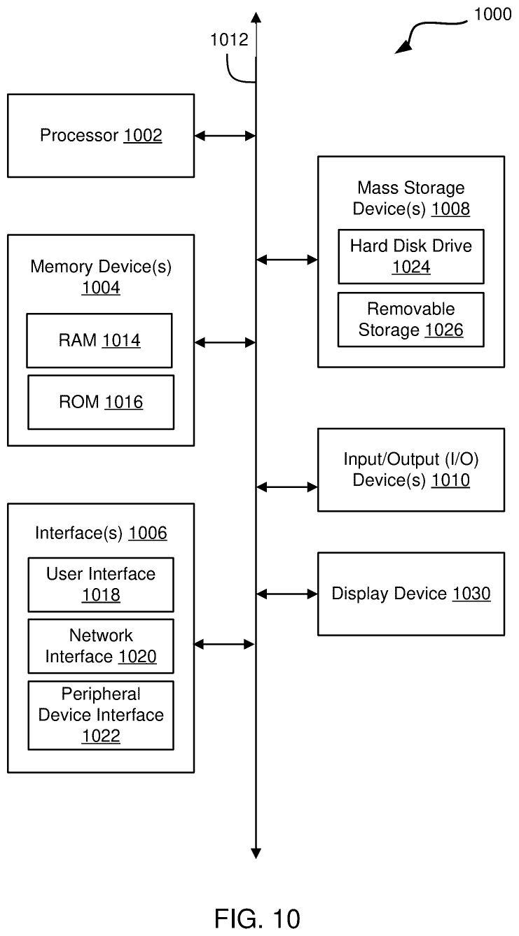

Referring now to FIG. 10, a block diagram of an example computing device 1000 is illustrated. Computing device 1000 may be used to perform various procedures, such as those discussed herein. Computing device 1000 can perform various monitoring functions as discussed herein, and can execute one or more application programs, such as the application programs or functionality described herein. Computing device 1000 can be any of a wide variety of computing devices, such as a desktop computer, in-dash computer, vehicle control system, a notebook computer, a server computer, a handheld computer, tablet computer and the like.

Computing device 1000 includes one or more processor(s) 1004, one or more memory device(s) 1004, one or more interface(s) 1006, one or more mass storage device(s) 1008, one or more Input/output (I/O) device(s) 1010, and a display device 1030 all of which are coupled to a bus 1012. Processor(s) 1004 include one or more processors or controllers that execute instructions stored in memory device(s) 1004 and/or mass storage device(s) 1008. Processor(s) 1004 may also include various types of computer-readable media, such as cache memory.

Memory device(s) 1004 include various computer-readable media, such as volatile memory (e.g., random access memory (RAM) 1014) and/or nonvolatile memory (e.g., read-only memory (ROM) 1016). Memory device(s) 1004 may also include rewritable ROM, such as Flash memory.

Mass storage device(s) 1008 include various computer readable media, such as magnetic tapes, magnetic disks, optical disks, solid-state memory (e.g., Flash memory), and so forth. As shown in FIG. 10, a particular mass storage device 1008 is a hard disk drive 1024. Various drives may also be included in mass storage device(s) 1008 to enable reading from and/or writing to the various computer readable media. Mass storage device(s) 1008 include removable media 1026 and/or non-removable media.

I/O device(s) 1010 include various devices that allow data and/or other information to be input to or retrieved from computing device 1000. Example I/O device(s) 1010 include cursor control devices, keyboards, keypads, microphones, monitors or other display devices, speakers, printers, network interface cards, modems, and the like.

Display device 1030 includes any type of device capable of displaying information to one or more users of computing device 1000. Examples of display device 1030 include a monitor, display terminal, video projection device, and the like.

Interface(s) 1006 include various interfaces that allow computing device 1000 to interact with other systems, devices, or computing environments. Example interface(s) 1006 may include any number of different network interfaces 1020, such as interfaces to local area networks (LANs), wide area networks (WANs), wireless networks, and the Internet. Other interface(s) include user interface 1018 and peripheral device interface 1022. The interface(s) 1006 may also include one or more user interface elements 1018. The interface(s) 1006 may also include one or more peripheral interfaces such as interfaces for printers, pointing devices (mice, track pad, or any suitable user interface now known to those of ordinary skill in the field, or later discovered), keyboards, and the like.

Bus 1012 allows processor(s) 1004, memory device(s) 1004, interface(s) 1006, mass storage device(s) 1008, and I/O device(s) 1010 to communicate with one another, as well as other devices or components coupled to bus 1012. Bus 1012 represents one or more of several types of bus structures, such as a system bus, PCI bus, IEEE bus, USB bus, and so forth.

### Examples

The following examples pertain to further embodiments.

Example 1 is a system. The system includes a surveillance device comprising a camera. The system includes a chime comprising a speaker for emitting an auditory notification.

Example 2 is a system as in Example 1, wherein the surveillance device is a doorbell surveillance device.

Example 3 is a system as in any of Examples 1-2, wherein the surveillance device further comprises a motion sensor.

Example 4 is a system as in any of Examples 1-3, wherein the surveillance device further comprises a microphone.

Example 5 is a system as in any of Examples 1-4, wherein the surveillance device further comprises a speaker.

Example 6 is a system as in any of Examples 1-5, wherein one or more of the surveillance device and the chime comprises dual connectivity.

Example 7 is a system as in any of Examples 1-6, wherein one or more of the surveillance device and the chime comprises a wireless antenna for receiving and transmitting wireless communications by way of a Wi-Fi® protocol.

Example 8 is a system as in any of Examples 1-7, wherein the wireless antenna is a 2.4 GHz antenna.

Example 9 is a system as in any of Examples 1-8, wherein one or more of the surveillance device and the chime further comprises a radiofrequency antenna.

Example 10 is a system as in any of Examples 1-9, wherein the radiofrequency antenna is a 433 MHz antenna.

Example 11 is a system as in any of Examples 1-10, wherein each of the surveillance device and the chime comprises dual connectivity such that each of the surveillance device and the chime comprises a wireless antenna for receiving and transmitting wireless communication by way of a Wi-Fi® protocol and further comprises a radiofrequency antenna.

Example 12 is a system as in any of Examples 1-11, wherein the surveillance device is configured to receive hardwired electrical power to draw power from an electrical system.

Example 13 is a system as in any of Examples 1-12, wherein the surveillance device further comprises a battery.

Example 14 is a system as in any of Examples 1-13, wherein the battery of the surveillance device is configured as a backup power source such that the surveillance device automatically draws power from the battery when the hardwired electrical connection fails.

Example 15 is a system as in any of Examples 1-14, wherein the chime comprises a battery and is further configured to draw power from a hardwired electrical connection.

Example 16 is a system as in any of Examples 1-15, wherein the battery of the surveillance device is replaceable.

Example 17 is a system as in any of Examples 1-16, wherein the chime comprises a means for charging the battery for the surveillance device.

Example 18 is a system as in any of Examples 1-17, wherein one or more of the surveillance device or the chime is configured to communicate with a security gateway.

Example 19 is a system as in any of Examples 1-18, wherein the surveillance device provides image data to the security gateway by way of a wireless communication protocol.

Example 20 is a system as in any of Examples 1-19, wherein the surveillance device is configured to wirelessly communicate with the chime, and wherein the surveillance device is configured to instruct the chime to emit an alarm when the surveillance device loses power from the hardwired electrical connection.

Example 21 is a system as in any of Examples 1-20, wherein the security gateway instructs the chime to emit an alarm in response to an alarm event, wherein the alarm event comprises a determination that an intruder is present at a building, and the intruder does not have authorization to be present at the building.

Example 22 is a system as in any of Examples 1-21, wherein the radiofrequency antenna is configured as a backup communication means such that the surveillance device relies on the radiofrequency antenna to reestablish a connection via the wireless antenna when the surveillance device can no longer communicate by way of the Wi-Fi® protocol.

Example 23 is a device. The device includes a camera, a high-frequency antenna configured to receive and transmit data over a wireless local area network, and a low-frequency radio transceiver configured to receive and transmit data.

Example 24 is a device as in Example 23, further comprising a doorbell actuator, and wherein the device is in electronic communication with a doorbell speaker.

Example 25 is a device as in any of Examples 23-24, further comprising: a battery; and a means for establishing a wired connection with a power supply.

Example 26 is a device as in any of Examples 23-25, wherein the battery is a rechargeable battery, and wherein the device further comprises a battery receptacle configured to receive the battery and establish an electronic interface with the battery, and wherein the battery is replaceable by sliding the battery out of the battery receptacle.

Example 27 is a device as in any of Examples 23-26, wherein the high-frequency antenna comprises a Wi-Fi® antenna.

Example 28 is a device as in any of Examples 23-27, wherein the high-frequency antenna is configured to receive and transmit the data over one or more of a 2.4 GHz waveband or a 5 GHz waveband.

Example 29 is a device as in any of Examples 23-28, wherein the low-frequency radio transceiver is configured to receive and transmit data over a 433 MHz waveband.

Example 30 is a device as in any of Examples 23-29, further comprising an infrared motion detection sensor.

Example 31 is a device as in any of Examples 23-30, further comprising a processor in communication with the camera and the infrared motion detection sensor, and wherein the processor is configured to execute instructions comprising: receiving an output signal from the infrared motion detection sensor, wherein the output signal indicates a change in infrared energy due to motion; and instructing the camera to capture a series of image frames in response to the change in infrared energy due to the motion.

Example 32 is a device as in any of Examples 23-31, wherein the instructions executed by the processor further comprise: causing the series of image frames captured by the camera to be transmitted to a server by way of the high-frequency antenna and the wireless local area network; and receiving instructions from the server indicating whether the camera should continue to capture new image frames based on a content of the series of image frames.

Example 33 is a device as in any of Examples 23-32, wherein the server assesses the series of image frames to determine whether the series of image frames detect a person near the camera.

Example 34 is a device as in any of Examples 23-33, wherein the instructions executed by the processor further comprise: receiving instructions from the server to actuate a doorbell based on a content of the series of images; and providing a signal to a doorbell speaker to cause the doorbell speaker to emit a sound.

Example 35 is a device as in any of Examples 23-34, wherein the device is a doorbell.

Example 36 is a device as in any of Examples 23-35, further comprising: a doorbell actuator; and a processor; wherein the processor instructs the camera to capture a series of image frames in response to a user activating the doorbell actuator.

Example 37 is a device as in any of Examples 23-36, further comprising a Wi-Fi® repeater, wherein the Wi-Fi® repeater extends a range of the wireless local area network by receiving a signal from the wireless local area network and rebroadcasting the signal to a region surrounding the device.

Example 38 is a device as in any of Examples 23-37, further comprising a processor, wherein the processor communicates with a user device by way of the low-frequency radio transceiver to receive login details for accessing the wireless local area network.

Example 39 is a system. The system includes a surveillance system server in communication with a network. The system includes a doorbell security sensor in communication with the surveillance system server, wherein the doorbell security sensor comprises: a camera; a high-frequency antenna configured to receive and transmit data over a wireless local area network; and a low-frequency radio transceiver configured to receive and transmit data. The system includes a chime in communication with the doorbell security sensor.

Example 40 is a system as in Example 39, wherein the doorbell security sensor further comprises an infrared motion detection sensor and a processor, wherein the processor is configured to execute instructions comprising: receiving an output signal from the infrared motion detection sensor, wherein the output signal indicates a change in infrared energy due to motion; and instructing the camera to capture a series of image frames in response to the change in infrared energy due to the motion.

Example 41 is a system as in any of Examples 39-40, wherein the instructions executed by the processor of the doorbell security sensor further comprise: causing the series of image frames captured by the camera to be transmitted to the surveillance system server by way of the high-frequency antenna and the wireless local area network; and receiving instructions from the surveillance system server indicating whether the camera should continue to capture new image frames based on a content of the series of image frames.

Example 42 is a system as in any of Examples 39-41, wherein the chime comprises: a Wi-Fi® signal repeater that rebroadcasts a signal for the wireless local area network; a battery charger; and a speaker, wherein the chime emits a sound from the speaker in response to receiving instructions from the doorbell security sensor.

Example 43 is a system. The system includes a server; a security gateway in communication with the server by way of a network, wherein the security gateway is installed at a location under surveillance; and a camera in communication with the security gateway, wherein the camera is installed at the location under surveillance. The system is such that the security gateway comprises a processor configured to execute instructions comprising receiving an alarm event from one or more sensors installed at the location under surveillance; and in response to receiving the alarm event, instructing the camera to capture a series of image frames.

Example 44 is a system as in Example 43, further comprising a smoke sensor in communication with the security gateway, and wherein the instructions further comprise: receiving a sensor readout from the smoke sensor indicating that smoke is detected; and in response to receiving the sensor readout, instructing the camera to capture the series of image frames.

Example 45 is a system as in any of Examples 43-44, further comprising a thermometer in communication with the security gateway, and wherein the instructions further comprise, in response to receiving the sensor readout, instructing the thermometer to capture a current temperature reading.

Example 46 is a system as in any of Examples 43-45, wherein the system comprises a plurality of cameras, and wherein the instructions further comprise: selecting a first camera of the plurality of cameras based on a proximity of the first camera to the smoke sensor; and instructing the first camera to capture the series of image frames.

Example 47 is a system as in any of Examples 43-46, wherein the instructions further comprise providing the series of images to the server, wherein the server is configured to assess the series of images to determine a probability that a fire is occurring at the location under surveillance.

Example 48 is a system as in any of Examples 43-47, further comprising a speaker in communication with the security gateway, and wherein the security gateway issues a notification in response to receiving an indication from the server that the fire is occurring at the location under surveillance, and wherein the notification comprises one or more of an audio emission, a light emission, a telephone call, or a message transmitted by way of the network.

Example 49 is a system as in any of Examples 43-48, further comprising an egress sensor in communication with the security gateway, wherein the egress sensor comprises one or more of a door sensor or a glass break sensor, and wherein the instructions further comprise: receiving a sensor readout from the egress sensor indicating that one or more of a door has been opened or a glass panel has been broken; and in response to receiving the sensor readout, instructing the camera to capture the series of image frames.

Example 50 is a system as in any of Examples 43-49, wherein the system comprises a plurality of cameras, and wherein the instructions further comprise: selecting a first camera of the plurality of cameras based on a proximity of the first camera to the egress sensor; and instructing the first camera to capture the series of image frames.

Example 51 is a system as in any of Examples 43-50, wherein the instructions further comprise providing the series of images to the server, wherein the server is configured to assess the series of images to determine a probability that an intruder has entered the location under surveillance.

Example 52 is a system as in any of Examples 43-51, further comprising a speaker in communication with the security gateway, and wherein the security gateway issues a notification in response to receiving an indication from the server that the fire is occurring at the location under surveillance, and wherein the notification comprises one or more of an audio emission, a light emission, a telephone call, or a message transmitted by way of the network.

Example 53 is a system as in any of Examples 43-52, wherein the camera is a component of a security device comprising: the camera; a high-frequency antenna configured to receive and transmit data over a wireless local area network; and a low-frequency radio transceiver configured to receive and transmit data.

Example 54 is a system as in any of Examples 43-53, wherein the security device communicates with the security gateway by way of the high-frequency antenna.

Example 55 is a system as in any of Examples 43-54, wherein the security device communicates with a user device by way of the low-frequency radio transceiver, and wherein the user device provides the security device with login details for communicating with the server by way of the wireless local area network.

Example 56 is a system as in any of Examples 43-55, further comprising a chime that comprises a speaker, wherein the security device further comprises a doorbell actuator, and wherein activation of the doorbell actuator causes the security device to provide a signal to the speaker of the chime.

Example 57 is a system as in any of Examples 43-56, wherein the chime further comprises a Wi-Fi® signal repeater that rebroadcasts a signal for the wireless local area network.

Example 58 is a system as in any of Examples 43-57, wherein the chime further comprises a battery charger for a battery, and wherein the battery is associated with the security device.

Example 59 is a system as in any of Examples 43-58, further comprising an infrared motion detection sensor in communication with the security gateway, and wherein the instructions further comprise: receiving an output signal from the infrared motion detection sensor, wherein the output signal indicates a change in infrared energy due to motion; and instructing the camera to capture a series of image frames in response to the change in infrared energy due to the motion.

In the above disclosure, reference has been made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, televisions, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to conduct one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A system comprising:
a server;
a security gateway in communication with the server by way of a network, wherein the security gateway is installed at a location under surveillance; and
a camera in communication with the security gateway, wherein the camera is installed at the location under surveillance;
wherein the security gateway comprises a processor configured to execute instructions comprising:
receiving an alarm event from one or more sensors installed at the location under surveillance; and
in response to receiving the alarm event, instructing the camera to capture a series of image frames.

2. The system of claim 1, further comprising a smoke sensor in communication with the security gateway, and wherein the instructions further comprise:
receiving a sensor readout from the smoke sensor indicating that smoke is detected; and
in response to receiving the sensor readout, instructing the camera to capture the series of image frames.

3. The system of claim 2, further comprising a thermometer in communication with the security gateway, and wherein the instructions further comprise, in response to receiving the sensor readout, instructing the thermometer to capture a current temperature reading.

4. The system of claim 2, wherein the system comprises a plurality of cameras, and wherein the instructions further comprise:
selecting a first camera of the plurality of cameras based on a proximity of the first camera to the smoke sensor; and
instructing the first camera to capture the series of image frames.

5. The system of claim 4, wherein the instructions further comprise providing the series of images to the server, wherein the server is configured to assess the series of images to determine a probability that a fire is occurring at the location under surveillance.

6. The system of claim 5, further comprising a speaker in communication with the security gateway, and wherein the security gateway issues a notification in response to receiving an indication from the server that the fire is occurring at the location under surveillance, and wherein the notification comprises one or more of an audio emission, a light emission, a telephone call, or a message transmitted by way of the network.

7. The system of claim 1, further comprising an egress sensor in communication with the security gateway, wherein the egress sensor comprises one or more of a door sensor or a glass break sensor, and wherein the instructions further comprise:
receiving a sensor readout from the egress sensor indicating that one or more of a door has been opened or a glass panel has been broken; and
in response to receiving the sensor readout, instructing the camera to capture the series of image frames.

8. The system of claim 7, wherein the system comprises a plurality of cameras, and wherein the instructions further comprise:
selecting a first camera of the plurality of cameras based on a proximity of the first camera to the egress sensor; and
instructing the first camera to capture the series of image frames.

9. The system of claim 8, wherein the instructions further comprise providing the series of images to the server, wherein the server is configured to assess the series of images to determine a probability that an intruder has entered the location under surveillance.

10. The system of claim 9, further comprising a speaker in communication with the security gateway, and wherein the security gateway issues a notification in response to receiving an indication from the server that the fire is occurring at the location under surveillance, and wherein the notification comprises one or more of an audio emission, a light emission, a telephone call, or a message transmitted by way of the network.

11. The system of claim 1, wherein the camera is a component of a security device comprising:
the camera;
a high-frequency antenna configured to receive and transmit data over a wireless local area network; and
a low-frequency radio transceiver configured to receive and transmit data.

12. The system of claim 11, wherein the security device communicates with the security gateway by way of the high-frequency antenna.

13. The system of claim 11, wherein the security device communicates with a user device by way of the low-frequency radio transceiver, and wherein the user device provides the security device with login details for communicating with the server by way of the wireless local area network.

14. The system of claim 11, further comprising a chime that comprises a speaker, wherein the security device further comprises a doorbell actuator, and wherein activation of the doorbell actuator causes the security device to provide a signal to the speaker of the chime.

15. The system of claim 14, wherein the chime further comprises a Wi-Fi® signal repeater that rebroadcasts a signal for the wireless local area network.

16. The system of claim 14, wherein the chime further comprises a battery charger for a battery, and wherein the battery is associated with the security device.

17. The system of claim 1, further comprising an infrared motion detection sensor in communication with the security gateway, and wherein the instructions further comprise:
receiving an output signal from the infrared motion detection sensor, wherein the output signal indicates a change in infrared energy due to motion; and
instructing the camera to capture a series of image frames in response to the change in infrared energy due to the motion.
